(19) United States
(12) Patent Application Publication
(10) Pub. No.: US 2002/0154346 A1
(43) Pub. Date: Oct. 24, 2002

(54) Scanning head module

(75) Inventor: Chui-Kuei Chiu, Hsin-Chu (TW)

Correspondence Address: LOWE HAUPTMAN GILMAN, & BERNER, LLP, 1700 Diagonal Road, Suite 310, Alexandria, VA, 22314, US

(73) Assignee: UMAX DATA SYTEMS INC.

(21) Appl. No.: 09/836,176

(22) Filed: Apr. 18, 2001

(51) Int. Cl. H04N 1/46

(52) U.S. Cl. 358/509; 358/505

(57) ABSTRACT

A scanning head module is provided. A photosensitive detector and a processing circuit are integrated in one module and installed on a main board so that a signal transmission line and a driving device for driving the processing circuit between the photosensitive detector and the processing circuit could be removed. Thus, the electrical magnetic interference (EMI) of the output signal of the photosensitive detector is significantly eliminated. The shielding of the scanning module for preventing electrical magnetic interference is also simplified.

### BACKGROUND OF THE INVENTION

1. Field of the Invention

The present invention relates to a scanning system, and more particularly to a scanning head module of a scanning system.

2. Description of the Prior Art

Please refer to FIG. 1. FIG. 1 is a schematically cross-sectional view of a prior scanner 10. The scanner 10 comprises a body 11 with a transparent platform 12 on its top end for placing a document to be scanned, and a scanner head 13 is movably installed under the transparent platform 12 for scanning the document placed on the transparent platform 12. The scanner head 13 slides on a belt 14 by way of a transmission means (not shown). The scanner head 13 usually comprises a housing 15 with a light source 16, an optical system including a set of mirrors 17 and a lens 18, a photosensitive detector 19, and a driving device 20 installed therein. The photosensitive detector 19, such as a CCD (charge coupled device), detects the image light focused thereon by the optical system reflected from the document. Referring to FIG. 3, the driving device 20 including three transistors provides driving capability to drive a processing unit installed in a main board 22. Referring to FIG. 2, the processing unit comprises an analog-to-digital converter (ADC) 23, a control circuit 24, such as an application specific integrated circuit (ASIC), a memory 25, an interface control circuit 26 and a motor control circuit 27. Referring to FIG. 3, the analog signal of the photosensitive detector 19 and the driving signal of the driving device 20 are transmitted to the processing unit through a cable 21. The analog-to-digital converter 23 digitizes the analog signal received from the photosensitive detector 19 and outputs the digitized signal to the control circuit 24. The information of the control circuit 24 is stored in the memory 25. And, the information of the control circuit 24 is outputted to a host through an interface 28 controlled by an interface control circuit 26.

In the prior scanner 10, the cable 21 connected between the scanner head 13 and the main board 22 transmits the analog signal of the photosensitive detector 19 and the driving signal of the driving device 20. When the scanner head 13 moves forward and backward to scan the document, the cable 21 is moved and even bent. Consequently, the analog signal transmitted in the cable 21 is easily subject to the electrical magnetic interference (EMI), resulting in an unacceptable output image. The electrical magnetic interference becomes more serious in a high speed scanning system. Moreover, the scanner head 13 and the processing unit placed on the main board 22 are separately installed in the body 11 of the scanner 10. The shielding of the scanner head 13 including the cable 21 and the processing unit to prevent electrical magnetic interference remains difficult.

Accordingly, it is an intention to provide a scanning head module to overcome the drawbacks of the prior scanner that's also applicable in a high speed scanning system.

### SUMMARY OF THE INVENTION

It is one objective of the present invention to provide a scanning head module, which integrates a photosensitive detector and a processing circuit on a main board so as to eliminate noise during output.

It is another objective of the present invention to provide a scanning head module, wherein an optical system, a photosensitive detector and a processing circuit all integrated into one module installed into a housing. Thus, the shielding of the scanning head module to prevent the electrical magnetic interference (EMI) is simplified.

It is a further objective of the present invention to provide a scanning head module, which integrates a photosensitive detector and a processing circuit in a main board. Therefore, a signal transmission line and a driving device for driving the processing circuit between the photosensitive detector and the processing circuit could be removed and the electrical magnetic interference (EMI) of the output signal of the photosensitive detector is significantly eliminated.

It is still a further objective of the present invention to provide a scanning head module to fulfill the demand of a high speed scanning system.

It is yet another objective of the present invention to provide a scanning head module applicable in a scanner, a copy machine, a facsimile machine and a multi functional peripheral.

In order to achieve the above objectives of this invention, the present invention provides a scanning head module comprising of, a light source and a housing with an optical system and a main board installed therein. The light source illuminates a document to be scanned. The optical system includes a set of mirrors and a lens assembly. The main board includes a photosensitive detector and a processing circuit. The illumination light coming from the document is guided by the set of mirrors and focused by the lens assembly onto the photosensitive detector. The processing circuit processes the signal received from the photosensitive detector. Since the photosensitive detector and the processing circuit are integrated in the main board, the output signal of the photosensitive detector could be transmitted to the processing circuit without through a transmission line. Therefore, the electrical magnetic interference of the output signal of the photosensitive detector is significantly eliminated.

### BRIEF DESCRIPTION OF THE DRAWINGS

The objectives and features of the present invention as well as advantages thereof will become apparent from the following detailed description, considered in conjunction with the accompanying drawings. It is to be understood, however, that the drawings, which are not to scale, are designed for the purpose of illustration and not as a definition of the limits of the invention, for which reference should be made to the appended claims.

FIG. 1 is a schematically cross-sectional view of a prior scanner;

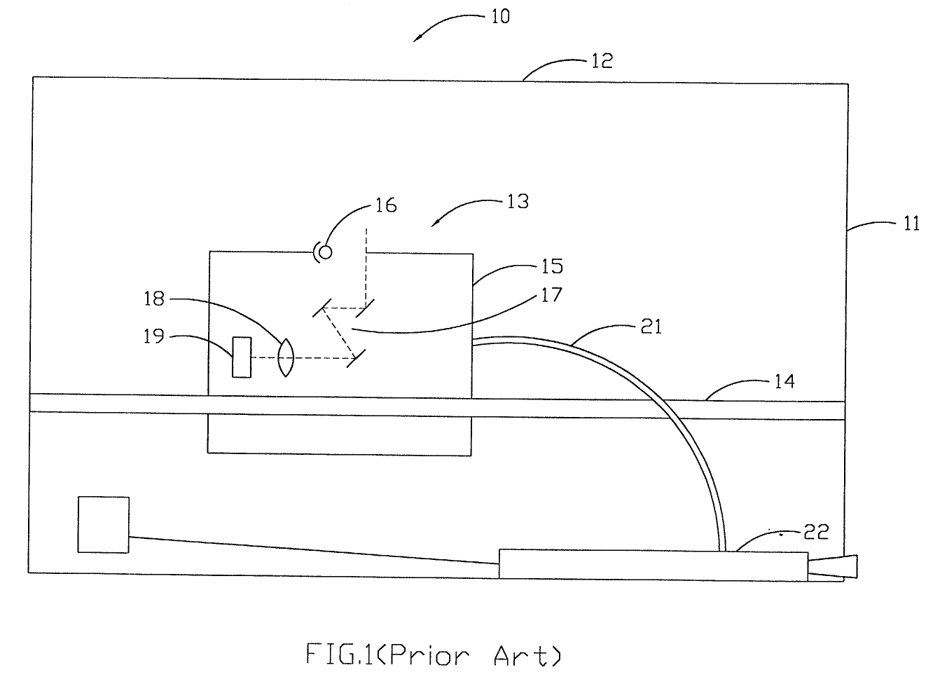

FIG. 2 is a function block diagram of a processing unit of the prior scanner of FIG. 1;

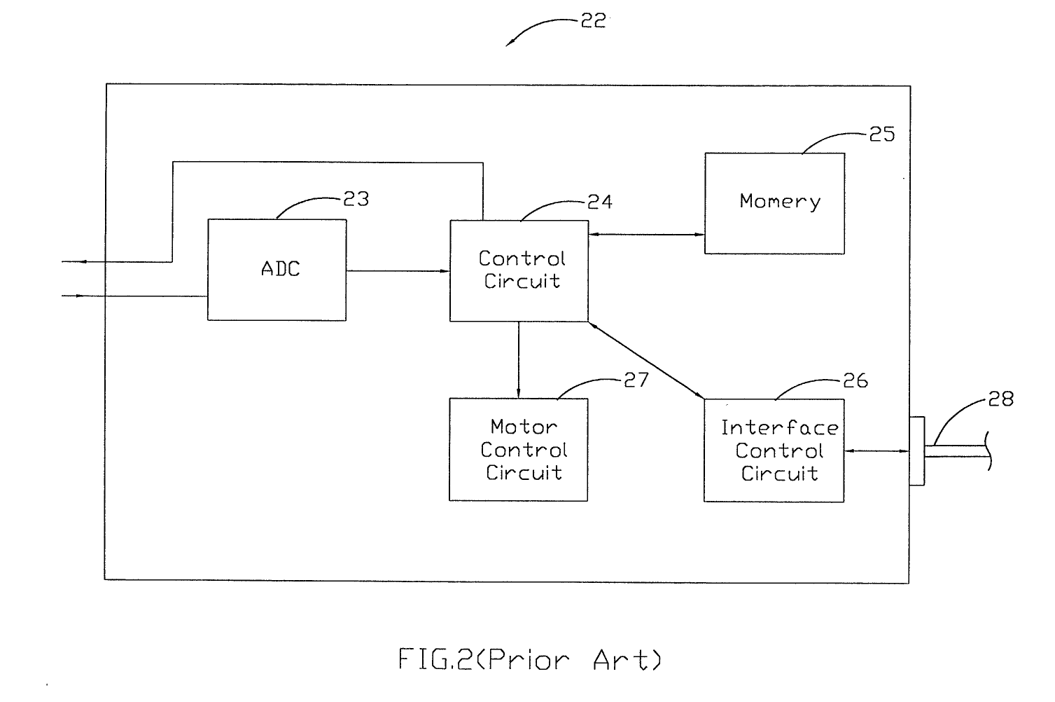

FIG. 3 is a schematic view for showing signal transmission between a scanner head and the processing unit of the prior scanner of FIG. 1;

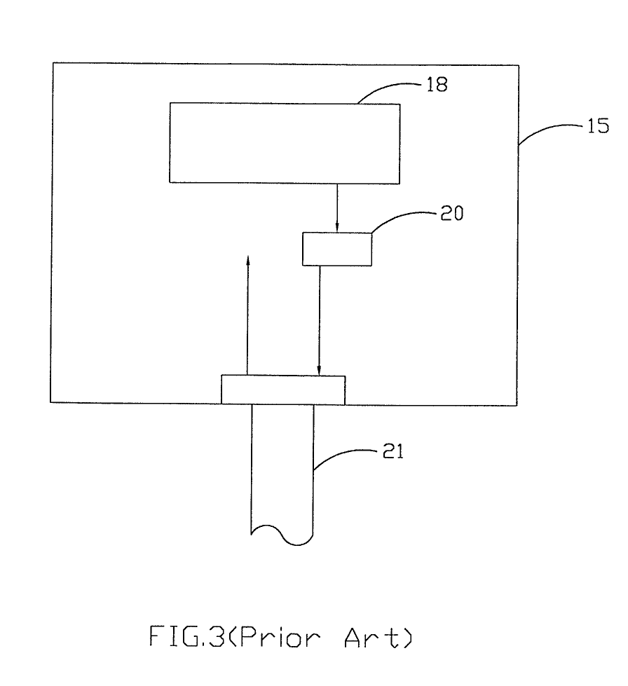

FIG. 4 is a schematically cross-sectional view of a scanning head module according to one embodiment of the present invention; and

FIG. 5 is a function block diagram of a main board of FIG. 4.

### DESCRIPTION OF THE EMBODIMENTS

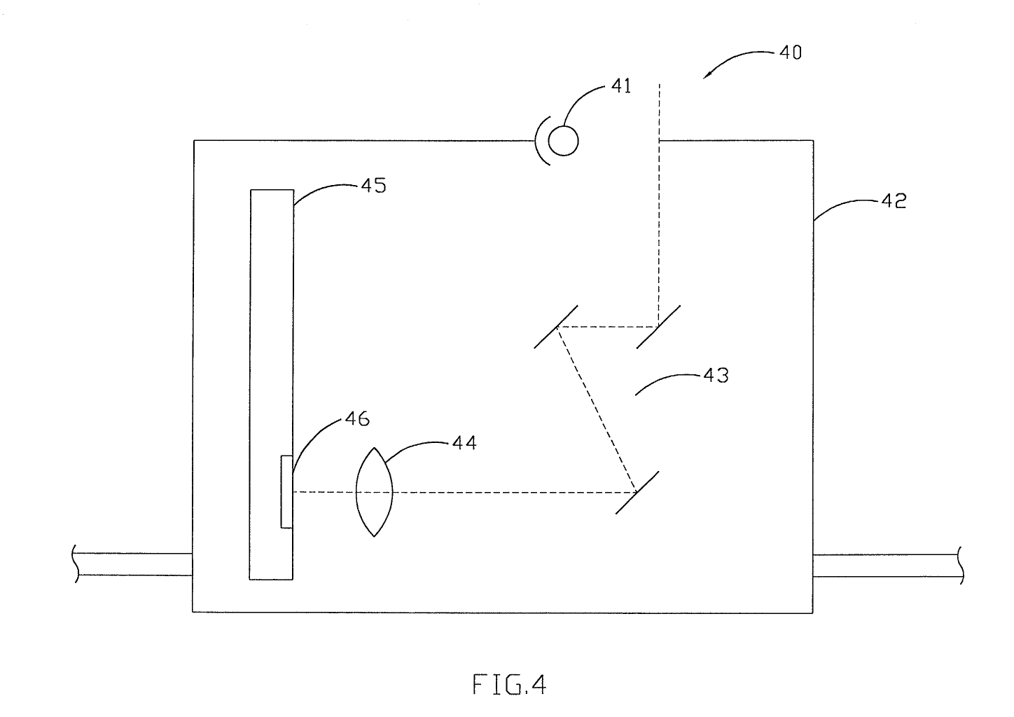

Please refer to FIG. 4. FIG. 4 is a schematically cross-sectional view of a scanning head module 40 in accordance with the present invention. The scanning head module 40 comprises: a light source 41 and a housing 42 including an optical system formed of a set of mirrors 43 and a lens assembly 44 and a main board 45. A light emitting diode (LED) can be used as the light source 41. A cold cathode fluorescent lamp (CCFL) can also be used as the light source 41. The main board 45 can be formed of polycarbonate (PC), and has a photosensitive detector 46, a processing circuit 47, a memory 50, an interface control circuit 51 and a motor control circuit 52 installed thereon.

The photosensitive detector 46 can be a charge coupled device (CCD), a CMOS sensor and a contact image sensor (CIS). The processing circuit 47 is comprised of an analog-to-digital converter circuit (ADC circuit) 48 and a control circuit 49, such as an application specific integrated circuit (ASIC). Alternately, the processing circuit 49 can be an application specific integrated circuit including an analog-to-digital converter circuit. The interface control circuit 51 can be formed of a universal series bus (USB). In addition, the interface control circuit 51 can be formed of IEEE 1394 series bus.

The light source 41 illuminates a document to be scanned, and then the optical path of the illumination light coming from the document is guided by the set of mirrors 43 and focused onto the photosensitive detector 46 by the lens assembly 44.

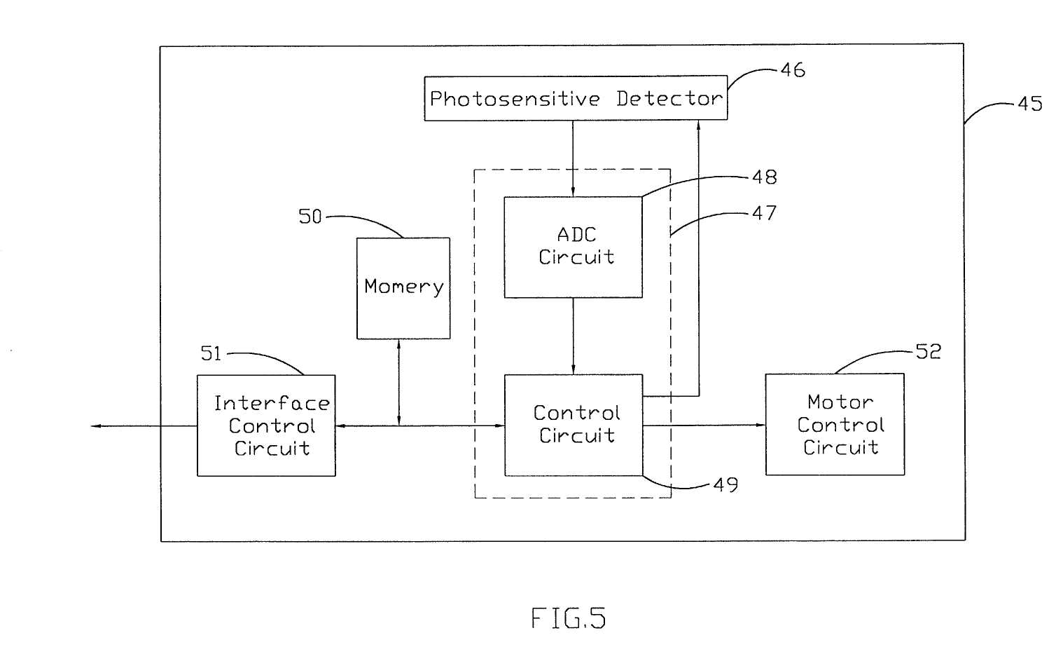

Referring to FIG. 5. FIG. 5 is a function block diagram of the main board 45. The analog signal, such as an image signal, of the photosensitive detector 46 is transmitted to the processing circuit 47. The analog-to-digital converter circuit 48 digitizes the analog signal received from the photosensitive detector 46 and then the control circuit 49, for example an application specific integrated circuit (ASIC), processes the digitized signal. The memory 50 is used for accessing the information of the control circuit 49. The interface control circuit 51 is connected to the control circuit 49 and served to transmit the output of the control circuit 49 to a host through an interface. The interface control circuit 51 also can be installed in a predetermined position outside the housing 42 of the scanning head module 40 to facilitate the interface connection between the scanning head module 40 and the host. The motor control circuit 52 is used to drive a motor (not shown) of a transmission means (not shown) for moving the scanning head module 40 when scanning a document. However, the motor control circuit 52 can be installed beside the motor, not on the main board 45.

The scanning head module 40 can be movably installed in a body of a scanning system to scan a document. The scanning head module 40 also can be fastened inside a body of a scanning system, while moving the carrier used for holding the document to be scanned. The scanning head module 40 is applicable to a scanner head of a scanner, a copy machine, a facsimile machine and a multi-functional peripheral.

The photosensitive detector 46 and the processing circuit 47 are integrated on the main board 45. The analog signal of the photosensitive detector 46 can be transmitted to the processing circuit 47 without going through a transmission line, such as a cable. The electrical magnetic interference (EMI) of the analog signal of the photosensitive detector 46 can be significantly eliminated, and the signal transmission speed is also facilitated. Therefore, the memory 50 of the scanning head module 40 is not absolutely needed and can be removed. Since it is not required to provide a transmission line, for example a cable, between the photosensitive detector 46 and the processing circuit 47, the signal being transmitted there-between is not decayed. Therefore, it is not necessary to install an additional driving device to provide driving capability to the processing circuit 47. Moreover, the shielding of the scanning head module 40 to prevent electrical magnetic interference (EMI) is also simplified.

The embodiments are only used to illustrate the present invention, not intended to limit the scope thereof. Many modifications of the embodiments can be made without departing from the spirit of the present invention.

What is claimed is:

1. A scanning head module, comprising:
a light source; and
a housing comprising an optical system and a main board; wherein
said light source illuminating a document to be scanned;
said optical system including a set of mirrors and a lens assembly;
said main board including a photosensitive detector and a processing circuit, wherein the illumination light from the document is guided by said set of mirrors and focused by said lens assembly onto said photosensitive detector, and said processing circuit processes the signal received from said photosensitive detector.

2. The scanning head module of claim 1, wherein said light source comprises a light emitting diode (LED).

3. The scanning head module of claim 1, wherein said light source comprises a cold cathode fluorescent lamp (CCFL).

4. The scanning head module of claim 1, wherein said photosensitive detector comprises a charge coupled device (CCD).

5. The scanning head module of claim 1, wherein said photosensitive detector comprises a CMOS sensor.

6. The scanning head module of claim 1, wherein said photosensitive detector comprises a contact image sensor (CIS).

7. The scanning head module of claim 1, wherein said processing circuit comprises an application specific integrated circuit (ASIC).

8. The scanning head module of claim 7, wherein said application specific integrated circuit comprises an analog-to-digital converter circuit (ADC circuit) for digitizing the signal received from said photosensitive detector.

9. The scanning head module of claim 1, wherein said processing circuit comprises an analog-to-digital converter circuit and an application specific integrated circuit, said analog-to-digital converter circuit digitizing the signal received from said photosensitive detector and said application specific integrated circuit processing the digitized output of said analog-to-digital converter circuit.

10. The scanning head module of claim 1, wherein said main board is formed of polycarbonate (PC).

11. The scanning head module of claim 1, wherein said main board further comprises a memory for accessing the information of said process circuit.

12. The scanning head module of claim 1, wherein said main board further comprises an interface control circuit for outputting the information of said processing circuit to a host through an interface.

13. The scanning head module of claim 1, wherein said interface control circuit comprises a universal series bus (USB).

14. The scanning head module of claim 1, wherein said interface control circuit comprises an IEEE1394 series bus.

15. The scanning head module of claim 1, wherein said main board further comprises a motor control circuit.

16. A use of the scanning head module of claim 1, wherein said scanning head module is used as a scanner head of a scanner.

17. A use of the scanning head module of claim 1, wherein said scanning head module is applicable in a copying machine.

18. A use of the scanning head module of claim 1, wherein said scanning head module is applicable in a facsimile machine.

19. A use of the scanning head module of claim 1, wherein said scanning head module is applicable in a multi function peripheral (MFP).

20. The scanning head module of claim 1, wherein said scanning head module is movably installed in a body of a scanning system.

21. The scanning head module of claim 1, wherein said scanning head module is fastened inside a body of a scanning system.

22. A scanning head module, comprising:
a light source; and
a housing comprising an optical system and a main board; wherein
said light source illuminating a document to be scanned;
said optical system including a set of mirrors and a lens assembly;
said main board including a photosensitive detector, a processing circuit, a memory and an interface control circuit, wherein the illumination light from the document is guided by said set of mirrors and focused by said lens assembly onto said photosensitive detector, and said processing circuit processes the signal received from said photosensitive detector, while said memory accesses the information of said processing circuit, and said interface control circuit outputs the information of said processing circuit to a host through an interface.

23. The scanning head module of claim 22, wherein said light source comprises a light emitting diode (LED).

24. The scanning head module of claim 22, wherein said light source comprises a cold cathode fluorescent lamp (CCFL).

25. The scanning head module of claim 22, wherein said photosensitive detector comprises a charge coupled device (CCD).

26. The scanning head module of claim 22, wherein said photosensitive detector comprises a CMOS sensor.

27. The scanning head module of claim 22, wherein said photosensitive detector comprises a contact image sensor (CIS).

28. The scanning head module of claim 22, wherein said processing circuit comprises an application specific integrated circuit (ASIC).

29. The scanning head module of claim 28, wherein said application specific integrated circuit comprises an analog-to-digital converter circuit (ADC circuit) for digitizing the signal received from said photosensitive detector.

30. The scanning head module of claim 22, wherein said processing circuit comprises an analog-to-digital converter circuit and an application specific integrated circuit, said analog-to-digital converter circuit digitizing the signal received from said photosensitive detector and said application specific integrated circuit processing the digitized output of said analog-to-digital converter circuit.

31. The scanning head module of claim 22, wherein said main board is formed of polycarbonate (PC).

32. The scanning head module of claim 22, wherein said interface control circuit comprises a universal series bus (USB).

33. The scanning head module of claim 22, wherein said interface control circuit comprises an IEEE1394 series bus.

34. The scanning head module of claim 22, wherein said main board further comprises a motor control circuit.

35. A use of the scanning head module of claim 22, wherein said scanning head module is used as a scanner head of a scanner.

36. A use of the scanning head module of claim 22, wherein said scanning head module is applicable in a copying machine.

37. A use of the scanning head module of claim 22, wherein said scanning head module is applicable in a facsimile machine.

38. A use of the scanning head module of claim 22, wherein said scanning head module is applicable in a multi function peripheral (MFP).

39. The scanning head module of claim 22, wherein said scanning head module is movably installed in a body of a scanning system.

40. The scanning head module of claim 22, wherein said scanning head module is fastened inside a body of a scanning system.
